(19) United States
(12) Patent Application Publication
(10) Pub. No.: US 2019/0158777 A1
(43) Pub. Date: May 23, 2019

(54) RECOMPRESSIVE SENSING, RESPARSIFIED SAMPLING, AND LIGHTSPACETIMELAPSE: MEANS, APPARATUS, AND METHODS FOR SPATIOTEMPORAL AND SPATIOTONAL TIMELAPSE AND INFINITELY LONG MEDIA OR MULTIMEDIA RECORDINGS IN FINITE MEMORY

(71) Applicants: Steve MANN, Toronto (CA); Michael SCHWANZER, Toronto (CA)

(72) Inventors: Steve MANN, Toronto (CA); Michael SCHWANZER, Toronto (CA)

(21) Appl. No.: 16/066,143

(22) PCT Filed: Dec. 30, 2016
(86) PCT No.: PCT/CA2016/051551

§ 371 Date: Oct. 18, 2018

(30) Foreign Application Priority Data
Dec. 30, 2015 (CA) 2916494

(51) Int. Cl. H04N 5/915; H04N 5/917

(52) U.S. Cl. CPC H04N 5/915; H04N 5/917

(57) ABSTRACT

A recompressed-sensing recording means, apparatus, device, or system captures one or more recordings, of possibly unknown or unbounded duration, into a finite memory, by resparsifying previously recorded sensor data in order to make room to store new incoming sensor data. In some embodiments this resparsification is recursive, resulting in a fraccular (fractally circular) buffer. In some embodiments a LightSpaceTimeLapse image capture means, apparatus, or system captures the passage or stoppage of time, by way of analyzing a scene or subject matter that is subject to changes in lighting or changes in the subject matter, or both. In some embodiments a sparse or reduced resolution test image is captured periodically, and a LightSpaceTime model is constructed to estimate changes in LightSpace or SpaceTime or both. Successive frames feed into a LightSpaceTime comparator which triggers full resolution capture into a finite memory at appropriate intervals. As the finite memory capacity approaches full capacity, the image repository is resparsified to make room for more new images. This resparsification is done by a decision process based on LightSpace and SpaceTime analysis. In some embodiments an intermediate LightSpaceTime format is captured and rendered as a background task resulting in an optimization that varies over time, depending on what is considered important in the LightSpaceTime continuum. All exposure and time values are preserved allowing an interpolated reconstruction at constant framerates or constant noveltyrates, as may be desired for artistic or epistemological purposes or for forensically accurate and irrefutable evidence.

### FIELD OF THE INVENTION

The present invention pertains generally to timelapse data recording or spacetimelapse photography, cinematography, multimedia capture, and the like.

### BACKGROUND OF THE INVENTION

David L. Donoho, in the Department of Statistics, at Stanford University, coined the term “Compressed Sensing”, for an important new field of research to which important contributions were also made by his PhD student Emmanuel Candes, and also Terence Tao. Compressed sensing allows electrical signals (audio recordings, visual recordings, radar, sonar, etc.) to be captured directly at a lower sampling rate than was previously believed to be necessary. See “Compressed Sensing”, Sep. 14, 2004 (preprint), which later appeared as Donoho, D. L. (2006). Compressed sensing, IEEE Transactions on Information Theory, 52(4), pp 1289-1306. See also IEEE Transactions on Information Theory, 2006, 52(2) pp. 489509, and 52(4) pp. 12891306, by E. Candes, et al.

More generally, signals with a finite rate of innovation (i.e. a finite number of degrees of freedom per unit of time) can be perfectly reconstructed when sampled above the rate of innovation. See “Sampling Signals With Finite Rate of Innovation” by Martin Vetterli, Pina Marziliano, and Thierry Blu, in IEEE TRANSACTIONS ON SIGNAL PROCESSING, VOL. 50, NO. 6, JUNE 2002, pp 1417-1428.

Existing work on Compressed Sensing gives precise reconstruction, and is highly useful in situations where provable exact reconstruction of a signal is required.

Photography has many uses in such contexts, e.g. for use in courtrooms, evidence, and also for photoquantigraphic and quantimetric sensing (“Intelligent Image Processing” by S. Mann, published by Wiley, 2001).

Another precise field of photography is photogrammetry, and the use of photography or projective geometry (in the days before photography) as a measurement tool. One of the important innovators in photogrammetry was Leonardo da Vinci, a scientist, inventor, and artist.

Photography also has an important place in the arts, where we are less concerned with being able to prove that we can get an exact reconstruction of a scene, and more interested in creating a visual representation that is compelling in an artistic, pictorial, or creative sense.

Photography is often used to help us see and understand our world, and the passage of time, whether, for example, to see things that are too fast for the human eye to observe (like a bullet going through an apple or playing card, as per Harold Edgerton's “Stopping Time”) or too slow for the human mind to comprehend (like a flower opening or like processes of creation that can be seen and understood in new ways using photography). Here we are not necessarily trying to prove that we can perfectly reconstruct reality, but, rather, simply that we can try and understand some aspects of the reality through a visual representation of it.

The word “photography” is a Greek word from “phos” or “photos” which, in Greek means “light”, and “graph” or “graphy” which means “drawing” or “painting”.

Therefore the word “photography” means “lightwriting” or “lightpainting” or “drawing or writing or painting with light”. Thus photography involves not only space and time, but also light. Photographs are made with an exposure to light, and generally a photograph integrates light during that exposure, over a certain time interval called the “exposure time” or simply the “exposure” (understood generally to be some time interval in some units of time).

Recordings are not limited to photographs or video, and may include sound as part of video, or audio-only recordings, or recordings of other phenomena like temperature, precipitation data (rainfall, snowfall, etc), wind speed, personal data like electrocardiograms, and the like.

### SUMMARY OF THE INVENTION

The invention generally consists of sensors such as audio, video, photographic, cameras, or the like, designed specifically for long-term timelapse media (e.g. image) capture, or goods or services or processors or systems for long-term timelapse capture, storage, processing, sharing, or the like. In some embodiments this is accomplished by a miniature self-contained low-power (solar or battery powered) recording apparatus, or for use with such an apparatus.

In embodiments of the invention that involve an actual physical recording device (such as a camera), the device is preferably housed in a waterproof enclosure that can work in wet rain, snow, or underwater. The housing may include flat surfaces in large quantity to make it easy to rest the device at various angles. For example, a polyhedral shape like an icosahedron or dodecahedron allows it to be set or rested at many different angles more so than the rectangular shape more common for recording devices like audio recoders, video recorders, and photographic cameras. In one embodiment a 26-sided shape (Rhombicuboctahedron) is used, where an octagon shape is extruded and then beveled in at an angle (such as 45 degrees) forwards and backwards (resulting in 3*8=24 sides), plus the front and back, giving a total of 26 sides. Many other shapes are also possible with the invention, preferably making it easy to orient the recording device in various directions to record data in various ways. Magnets or suction cups or threaded holes (¼ inch at 20 threads per inch on one or more surfaces for standard tripod or ceiling mount), or other adhesion means in or on the device, allow it to be stuck to many different surfaces and objects in many different ways. In typical embodiments, one or more audio, visual, or other sensors, such as a waterproof wide-angle lens, captures what is happening in the environment around the recording device. The side panels may also include photovoltaic media to help improve battery life by charging off sunlight, so that the device can be powered by sunlight alone, or by a combination of sunlight, stored energy, and energy harvested in other ways such as by harvesting energy sources like sound and radio in the environment, by induction from a dedicated nearby charging source, or by thermal temperature differentials, or the like.

In some embodiments, an intelligent machine learning algorithm in the device senses the amount of sunlight and the device “learns” what electrical budget is present, and thus adapts itself to capture more data during the daytime when, for example, sunlight is present as an energy source, while conserving energy during dark nights to keep watch with more careful consumption of power. In this way, more images are captured in bright light when exposures are short and they also have more quality, and then in lower light, a smaller number of longer exposures are made. Low light pictures tend to be less sharp and require less spatial resolution, and a general idea of what is happening in a cityscape or street scene, for example, can be captured by a smaller number of long-exposure pictures that show light trails of car traffic, rather than trying to see each car sharp and clear.

In some embodiments a viewfinder and aiming function allows connection through Low Energy Bluetooth with smartphones or other display and control devices to adjust camera settings. In other embodiments the settings are adjusted automatically by a simple machine learning algorithm.

Some embodiments of the invention include a space utilization optimizer: A simple 1 button start and stop function is provided, along with also an automated start and stop, which captures locally images (and best utilizes storage and power budgets) until a wireless connection or other connection is discovered to offload and restart or partially restart the space utilization optimizer of the invention.

Some embodiments of the invention use a sparsifier, resparsifier, victor, or revictor. Upload of the images to external storage is a feature of some embodiments of the invention that extends capture and reduces the need for (re)sparsification of the images or (r)eviction of LightSpace or SpaceTime information. Wireless or wired connection is used, or also a memory card or similar device is used and can be offloaded by hand by the user or automatically, thus resetting a LightSpaceTime optimizer.

In some embodiments the camera may need to go for a long time without wireless connectivity and thus must make the best of the situation without “knowing” in advance how long it might need to capture. It might sit for several months without connectivity and thus there must be a “best” capture of the subject matter over that time period, e.g. perhaps an entire winter in an area that is inaccessible during winter.

In the simplest embodiment, pictures are captured at a steady frame rate like once every 2 minutes is about right for sunlight moving through a scene and still looking “smooth”. In some situations the only innovation might be due to changes in light. For example, a static scene under changing sunlight, where the shadows move across the scene, is an artistically visually interesting effect, having a very limited number of degrees of freedom. In this sense, Compressed Sensing is applied to Lightspace, so that the image is expressed using Lightvectors, as described in the above mentioned “Intelligent Image Processing” book. Typically, rather than capture one image, say, every 2 minutes, we capture a set of images each 2 minutes, so that we obtain a photoquanitigraph of the scene (“Intelligent Image Processing”, Chapter 4). Every 2 minutes the camera analyzes the scene and determines the number of exposures needed for HDR (High Dynamic Range), based on contrast, etc.

Embodiments of the invention may be used to visualize phenomenology through photographic time-exposures, e.g. to visualize “sitting waves” from radio, where a superheterodyne receiver brings a radio wave down to baseband so that it “sits still” to be photographed, as light trails from a Sequential Wave Imprinting Machine. See “Phenomenal Augmented Reality” by S. Mann, IEEE Consumer Electronics, Vol. 4, Number 4, October 2015, Cover+pp 92-97. More generally, a SWIM (Sequential Wave Imprinting Machine) or other similar array of lamps can be used as a light source, or we can simply allow natural sunlight to be used like an array of light sources, owing to the fact that it generates a lightspace of images, which form a certain kind of sparse representation into imagespace.

In other embodiments, (re)compressed feedback is used, i.e. (re)compressed control systems. (Re)compressed Sensing is half of this situation, of control theory, that uses both observability and controllability. The other half is given by (re)compressed affectation. For example, the pattern of light presented to a SWIM is a vector, i.e. a lightvector in a lightspace. Lightspace more generally is the tensor outer product of a lightfield with a time-reversed lightfield, and therefore admits itself as a problem in control systems, and thus combines (re)compressed sensing with (re)compressed display or output. In situations where there is artificial light, the light sources work in reverse of a camera in those embodiments. The Nipgow disk system of early television essentially uses a 1-pixel camera, together with a light source that is spatially varying. Thus if we apply compressed display to the light source, we get lightvectors that form a basis of lightspace. So the invention can be used with smart lights, such as indoor lights, LED lighting, etc. In some embodiments, the camera becomes a lock-in camera, locked in to lights and lighting so as to measure or sense lightspace without flicker of the lights being perceptible to others, who might otherwise find this annoying.

In other embodiments, natural light is simply selected and sifted out to create the lightvectors, and used for compressed lightspaces.

Let's suppose on a sunny day that 2 or 3 exposures suffice, then every 2 minutes a quantigraph (quantimetric photograph) is captured using HDR, and stored. Let's call these quantigraphs or photographs “frames”, so we now have let's say “frame 1”, “frame 2”, etc., and once the memory is almost full, what we do is begin to “evict” the odd numbered frames from the beginning only. So this results in a (re)sparsification of older data to make room for new data. As a result we have full frame rate for new data and reduced frame rate for older data. This resparsification is applied recursively, to recompress the data. Some embodiments of the invention use Compressed Sensing (such as Lightvectors rather than working in imagespace, e.g. resulting in Compressed Lightfield Sensing), and in these embodiments, we recompress using the lightvectors each time we run out of space. This gives rise to something we call “Recompressive Sensing” or “Recompressed Sensing”.

Embodiments of the invention typically use a variety of such resparsification algorithms. A very simple resparsification algorithm is to recompress older frames with more severe JPEG (Joint Picture Experts Group) compression, i.e. reduce the “Quality” of older images to make room for new images. More generally, whatever the transform used to represent the images, it is revisited and revised recursively to continue to downsize the storage requirements incrementally. Generally images are captured with some kind of sparsifying transform such as the Discrete Cosine Transform (DCT), or the Wavelet Transform (as is used in JPEG-2000), and other approaches include also the Chirplet Transform, etc., if we desire to capture also the essence of periodicty-in-perspective (algebraic projective geometry). See for example “Wavelets and chirplets: Time-frequency perspectives, with applications.”, by S. Mann, in “Advances in Machine Vision, Strategies and Applications” (1992).

More generally speaking, we execute a form of early-data reduction or “early pruning” to make room for new data.

In this way we never run out of space, and can record for an infinite timelapse using only a finite memory capacity. If there's enough power (e.g. solar power) but limited memory, we can record for many years, and in such a way that our newest memories are top-quality, but our older memories “fade” through framerate reduction, quality reduction, resolution reduction, and the like.

Thus we have a “forgetting function” that works much like human memory, where older things become “foggy” or “fuzzy” but never completely lost or completely forgotten.

This will work well in situations where a user sets up a camera and doesnt know a-priori how long the camera will remain setup (potentially many years). Thus an important aspect of the invention is to dynamically change the information density, quality, fidelity, or bandwidth of existing recordings to make room for more recordings.

Consider the following example in which there is lots of electrical power (e.g. perhaps a solar panel and lots of sun) but no access to online storage:
A typical video camera records about 60 frames per second for about 8 hours before it is “full” (no more memory capacity). This is about 1,728,000 frames. If we knew a-priori, that we were going to record for 16 hours, we'd maybe reduce the framerate to 30 frames per second. If we knew we needed to record for 20 days, we′d simply select a frame rate of one frame per second, since there are 1728000 seconds in 20 days. Sound (audio) and other data such as time, temperature, rainfall, etc., is also recorded in some implementations. These quantities are recorded often at a very high sampling rate, not knowing a-priori how much bandwidth the signals they are recording will have. Typically there is a specific finite duration over which recordings can be made before memory will fill up.
But we often don't know how long we′d like to record for.
With the invention we have the camera or other recording device setup and recording at a particular sampling rate, which then gets reduced over time, while using a resparsifier to delete or (re)sparsify some but not all of older data to make room for new data. In the case of audio recorders, we record at a high sampling rate like 96,000 samples per second (typical of high quality audio recorders), until memory is full, and then we drop to 48,000 samples per second, while going back and deleting every second sample of the original recording to make room for the new recording.
In the case of video, we begin by recording at 60 frames per second, and when the memory is almost full, we prune the images by deleting odd numbered frames starting at the beginning, to make room for new frames coming in. So once memory is almost full, we decide to do two things:
   reduce incoming frame rate to half, i.e. 30 frames per second;
   each time a new frame comes in, delete the oldest frame that has an odd frame number.
At a time of 16 hours from the beginning (from when the recording was started) we'll have a recording of the entire 16 hours (twice the original 8 hour time interval) but at only 30 fps (frames per second) instead of 60 fps.
We call this point-in-time “prune level 1”, i.e. one iteration of our pruning algorithm, as performed by a device we call a (re)sparsifier.
At time 32 hours we'll be at “prune level 2” (two iterations) and we'll have a 32 hour long recording at 15 fps, at which time the resparsifier will have run through the data twice.
Let's suppose now that we get distracted from this whole setup, or maybe just leave it and forget about it. After 20 days we'll be at “prune level 60” (sixty iterations) and we'll have a 20 day recording at lfps.
After forty days we'll have a recording at 0.5 fps, i.e. images with a time interval of two seconds. A recording of a single frame every two seconds, for forty days, is useful for understanding the passage of time in a typical scene or subject matter like a home renovation project or the creation of to an artwork or painting.
Commercial construction projects have known and planned scope where framerates can be decided a-priori. Likewise police and security surveillance have known requirements dictated by law or policy like a requirement to keep images for a specific and previously agreed upon time interval of liability.
But individual artists and homeowners and teachers, etc., often undertake less planned activities like if a father wants to build a model train set with his daughter, he might not know how long this will take to complete.
For this reason, sousveillance (undersight) is best served by the proposed invention, whereas surveillance (oversight) can be addressed by prior art.
Continuing our example, if we had a home renovation project, or simply home life, we might just leave the camera setup and forget about it, and after another sixty times as long (“prune level” 60*60=3600) we'll have recorded more than 3 years of activity, at the rate of one frame each minute.
After about six and a half years, we'll be at prune level 7200 with a picture every two minutes, which is still dense enough to appreciate and understand the passage of time in natural sunlight with the movement of light and shade and shadow.

In general timelapse we might not begin at 60 fps, i.e. for applications specific to timelapse we might start at something like one frame per second.

A still frame is captured once per second, until storage or memory capacity is almost full, after 20 days. Instead of stopping the recording when the memory is full, the system identifies the highest density of frames (time based) within the existing recording to identify which frame is next to be evicted (deleted). In this way, the memory never fills up because each time a new frame comes in, an old frame is evicted, but not merely all at the beginning as in a regular circular buffer. Regular surveillance cameras use a circular buffer so you only get the last 48 hours or the last 30 days or the last of some specific time interval or memory capacity.

But rather than deleting the oldest frame, we delete one of the older frames in a systematic way that (re)sparsifies rather than completely eliminates old data.

In this way our memory is always almost full but always holds timelapse footage that extends all the way back to the beginning of when the recording started (albeit at reduced frame rate or quality or the like near the beginning).

After 60 iterations of this process (i.e. almost running out of memory 60 times) the stretches from the first captured still to the next one in memory will be 1 minute instead of one second. So at this point the frame rate has dropped to 1/60th of its original, and the total time recorded is 60 times as much. So we're now at capturing one image per minute with a total capture of just over 3 years.

The benefit is that a timelapse with a minute interval from still to still from when the capturing progress started is available in memory and captured in this example for over 3 years, which, in many situations, is better than only having the most recent 20 days (which is what would happen if using a standard circular buffer).

More generally we wish to address the question of what data needs to be deleted to make space for new incoming data. In surveillance applications predictability is important because it works with high-level decision makers who are generally “planners”. But in our case, or market is “tinkering” rather than “planning”, i.e. sousveillance (undersight). So we′d prefer to have stills which are timestamped to give a “best effort” at providing the best choice of stills possible within limited memory.

The above eviction algorithm does not require a great deal of processing power. and enables infinite timelapse photography within limited space (memory), without wireless connectivity, while always having the most dense footage available considering the limited space.

In another aspect of the invention, rather than completely delete all the outlying frames at each level of the resparsity pyramid, we instead construct a quality pyramid in which images are recompressed using a lower JPEG quality to make room for new images at full quality. In some embodiments, the recompression is based on new information, and trend extrapolation, i.e. as we learn more about the underlying signal to or phenomenology, we can apply recompressed sensing to compress older memories based on new information we learn about the underlying signal structure and reality of the situation being recorded. In other aspects of the invention, new space is made by an optimal combination of the following:
temporal resparsification of older image data;
spatial resparsification of older image data (e.g. reducing the resolution of older images);
fidelic resparsification of older image data (e.g. by compression at reduced quality, reduced definition, reduced dynamic range, etc.).
   In some embodiments a combination of these methods are used.

In the old days of cinema, before sound, there was no need for a constant frame rate. So in parts of the movie where action was faster, the camera operator would crank faster (they didn't have motors running the film in those days). In slow boring parts the camera operator would crank the film slower. Then there was instructions for the projectionist saying how fast the film should be cranked at various parts in the movie. This was a really good way to use film because it saved wasted film, and optimized frame rate depending on how things were happening in the scene.

It was not until the introduction of sound (audio) that film became shot at a fixed frame rate out of need to make the audio sound proper.

The present invention does something similar, i.e. optimal pruning based on activity and change.

The present invention, in one aspect, looks at the LightSpaceTime continuum to figure out how to space out the capture based on what's happening in the scene. Images are time-stamped in case there is a desire to interpolate back a constant-frame rate output (e.g. if it is need for use in court or for accurate motion studies or calculations, etc.), but otherwise a more artistically useful recording can be made in which very little effort is required on the part of the user to make a beautiful visual summary of a project.

Other useful aspects of the invention include additional sensors to help make timelapse useful and fun and interactive. For example, a geophone in the camera body senses touch and scratch and vibration as a way of controlling the flow of timelapse information. In one embodiment a radar system also senses the environment and grabs one picture for each unit of Doppler signal. As the memory fills up, pruning may thus be done on units of Doppler as a measure of novelty in the image sequence progression.

The present invention includes aspects that provide benefits to the collection and storage of footage from any streaming video camera, as the collection can be selective and the storage be optimized.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 illustrates an embodiment of the invention having a comparator for identifying a novelty aspect of a sparse stream of media files such as pictures, sounds, videos, or images and then capturing full images based on comparison with a novelty threshold, so that these can be pruned over time based on novelty.

FIG. 2 illustrates a simple embodiment of the invention, by way of a TimeEl (Time Element) Matrix, with rows that indicate points in time, and columns that indicate memory element usage by way of corresponding time of the memory element holdings.

FIG. 3 illustrates examples of TimeEl (Time Element) Matrices for a simple example of four memory frames recording various amounts of recoded data.

FIG. 4 illustrates a Fraccular Buffer embodiment of the invention.

FIG. 5 illustrates a Humanistic Memory™ system, buffer, or the like, embodiment of the invention.

FIG. 6 illustrates a lightspace timelapse embodiment of the invention.

FIG. 7 illustrates a recompressive sensing embodiment of Humanistic Memory that has “flashbulb memory”.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

In various aspects of the present invention, references to “microphone” can mean any device or collection of devices capable of determining pressure, or changes in pressure, or flow, or changes in flow, in any medium, be it solid, liquid, or gas.

Likewise the term “geophone” describes any of a variety of pressure transducers, pressure sensors, velocity sensors, or flow sensors that convert changes in pressure or velocity or movement or compression and rarefaction in solid matter to electrical signals. Geophones may include differential pressure sensors, as well as absolute pressure sensors, strain gauges, flex sensors on solid surfaces like tabletops, and the like. Thus a geophone may have a single “listening” port or dual ports, one on each side of a glass or ceramic plate, stainless steel diaphragm, or the like, or may also include pressure sensors that respond only to discrete changes in pressure, such as a pressure switch which may be regarded as a 1-bit geophone. Moreover, the term “geophone” can also describe devices that only respond to changes in pressure or pressure difference, i.e. to devices that cannot convey a static pressure or static pressure differences. More particularly, the term “geophone” is used to describe pressure sensors that sense pressure or pressure changes in any frequency range whether or not the frequency range is within the range of human hearing, or subsonic (including all the way down to zero cycles per second) or ultrasonic.

Moreover, the term “geophone” is used to describe any kind of “contact microphone” or similar transducer that senses or can sense vibrations or pressure or pressure changes in solid matter. Thus the term “geophone” describes contact microphones that work in audible frequency ranges as well as other pressure sensors that work in any frequency range, not just audible frequencies. A geophone can sense sound vibrations in a tabletop, “scratching”, pressing downward pressure, weight on the table, i.e. “DC (Direct Current) offset”, as well as small-signal vibrations, i.e. AC (Alternating Current) signals.

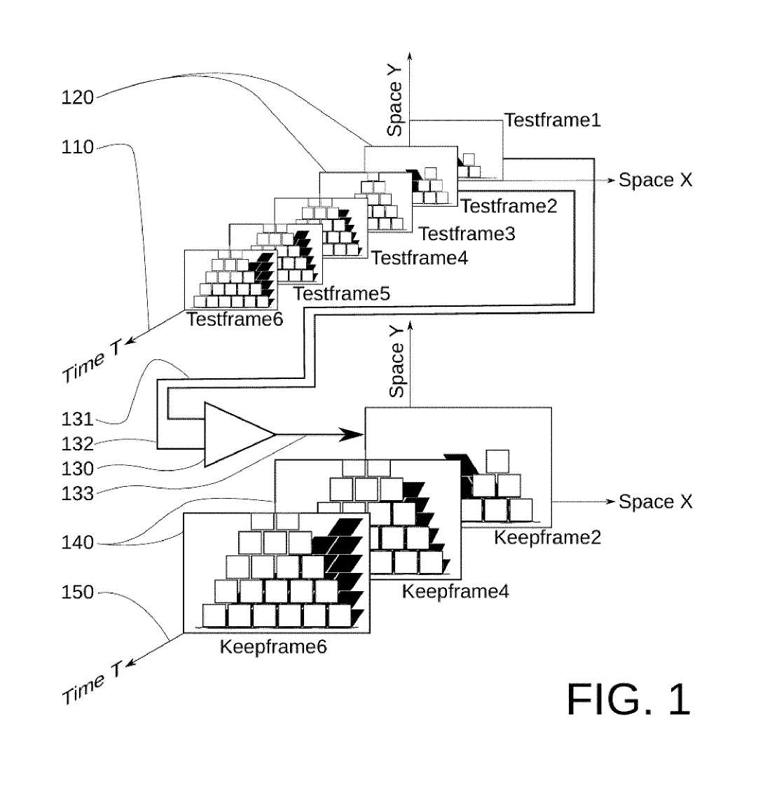

FIG. 1 illustrates an aspect of the invention showing two views of a spime (space time) continuum at high and low framerates.

Spime 110 is defined by spatial axes “Space X”, “Space Y”, and “Time T” which set forth as a “stack” of pictures that have spatial dimensions “X” and “Y”, acquired along a temporal dimension “T”. Here we consider a camera sensor array, but equally valid is to consider RaDAR (Radio Direction And Ranging), LiDAR (Light Direction And Ranging), SoNAR, ToF (Time of Flight), or other multidimensional image capture devices that capture spatiotemporal fields of sensory information. A satisfactory sensor is a CCD (Charge Coupled Device) array or the like, which can be read sparsely or at reduced resolution, at low power consumption.

Images in spime 110 are denoted as Testframe1, Testframe2, . . . through to Testframe6, although in practice the frame count goes much higher. These testframes denoted as Testframes 120 are each a snapshot in space, at a particular instant in time. Pairs of testframes are analyzed in terms of features, by way of a feature extractor in a processor, responsive to an input from the camera. The processed images produce a signal vector or feature vector, as per, for example, Lightspace (Intelligent Image Processing textbook by Steve Mann, published by Wiley, 2001), or VideoOrbits, or any other suitable feature system. This results in signals 131 and 132 here by example from Testframe1 and Testframe2. These signals are compared and a comparison signal 133 indicates how similar the testframes 120 are. When there is determined to be enough novelty, by way of a novelty threshold on comparator 130, the processor captures a full image set at full resolution, and these full exposures are synthesized into Keepframes 140. Keepframes are full-resolution frames generated when there is enough new information in the scene to warrant this. These are denoted in spime 150.

A common problem in timelapse photography is light flicker. Thus a lightspace model is set forth and in the Testframes may sense for example sun and cloud cover, etc., and try and capture images when the sun is shining, so that they all look the same more or less. Thus on a day when there is sun and cloud moving cover, we try to grab pictures at the instant the sun comes through the clouds, and mark these as preferred images evicted last. So as the eviction happens (when the memory is near full) we start to prune the flickery outliers and keep more of the steady images that are more similar to each other in lightspace but more different from each other in scene novelty.

This happens through Machine Learning and AI (Artificial Intelligence), whereby the processor looks to favour capture of images that are “steady but different (novel)”:
Steady: we want images that are captured at an instant in which the “signal” is high and the “noise” is low; and
Novel: we want a set of images in which each new image conveys a reasonable novelty, i.e. we don't want thousands of pictures of the same empty space with no change between them.

We can think of this as a signal-to-noise ratio, i.e. change due to flicker is what we don't want, and change due to actual scene subject matter movement is what we do want.

Note that the change in shadows is often “signal” not noise, i.e. the smooth graceful movement of the shadows in a scene is quite nice artistically, once the flicker of clouds is filtered out.

Cloud movement itself can also be nice if in a smooth and steady fashion, while revealing the right amount of novelty.

As can be seen, there is a process for measuring novelty. Each image has a header, e.g. in the JPEG header, we can store the novelty and various sensor and processor parameters and information like timestamp, and the like, that helps us later on.

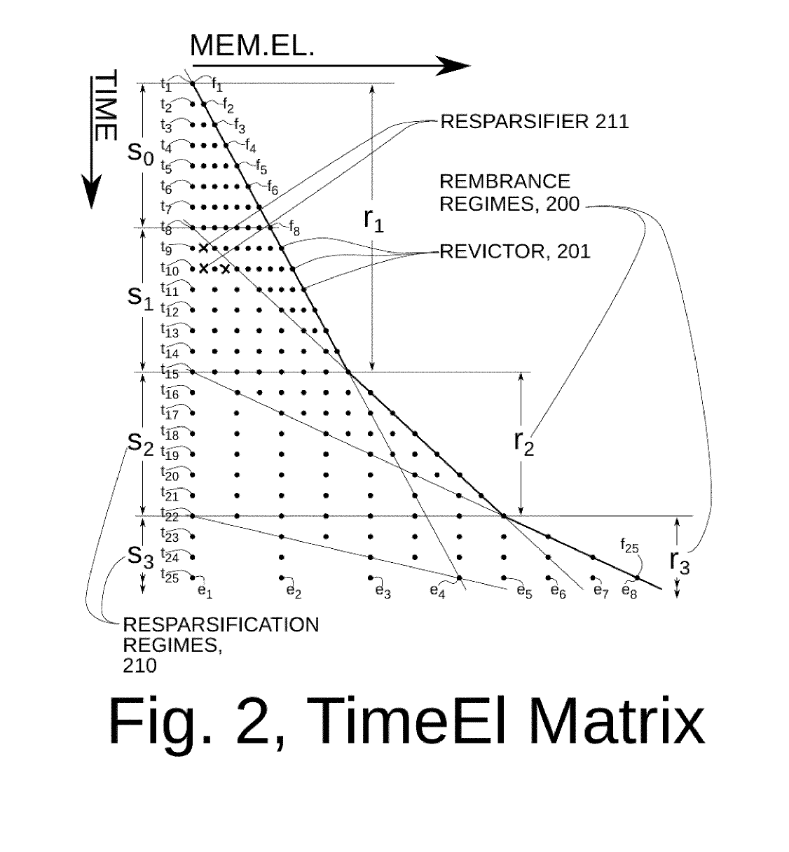

FIG. 2 illustrates a simple embodiment of the invention, by way of a TimeEl (Time Element) Matrix. The TimeEl Matrix will be used as a way to precisely specify enablements, algorithms, and embodiments of various aspects of the invention.

The matrix is not necessarily required to be stored in a memory to implement the invention, but serves as a way to understand and precisely specify enabling aspects of the invention.

Rows of the matrix indicate points in time, i.e. each row indicates a particular point in time. The points in time need not necessarily be equally spaced apart in time. In some embodiments the time samples are based on innovation in the subject matter being recorded. Audio, visual, or other “scene innovation”, in some embodiments, is measured. For images or video or pictures, this is done according to a distance of an orbit of a projective group of coordinate transformations, such as, for example, variation along an orbit of algebraic projective geometry such as might happen when the scene changes enough, as outlined in the textbook “Intelligent Image Processing”, author S. Mann, publisher Wiley, 2001. In some embodiments a full fidelity sample or image frame is grabbed at time t₁, and stored, and then new incoming images are grabbed at low fidelity to save battery power. Each of these incoming image frames is compared with the one grabbed at time t₁ and when there is sufficient difference or sufficient novelty or sufficient innovation, there is another full fidelity image frame captured at what is declared as time t₂. The process continues, filling up each memory element with sufficiently different information so as to capture the activity in a space or scene or subject matter in front of the camera or cameras to which the apparatus is applied. In some embodiments there are multiple synchronized cameras. In some embodiments there are also multiple synchronized light sources, and the novelty or innovation of the image subject matter is sensed in lightspace as well as imagespace, where lightspace is defined as per the above-mentioned “Intelligent Image Processing” textbook.

The top row, in FIG. 2, indicates an initial condition, at time, t₁, when the device begins recording. The top row shows only one sample, e.g. sample of audio, sample of temperature data, sample of precipitation data, sample of electrocardiogram data, or image frame. In embodiments of the invention used for photographic sensing, one frame, frame f₁, captured at time t₁, and stored in an element of memory, denoted as memory element e₁. Frame f₁, and its location in memory element e₁, is represented by a dot (a black circle filled in solid). The second row indicates the situation at a second point in time, t₂. In some embodiments the points in time can be uniformly spaced in time, whereas in other embodiments the points in time are chosen such that the images are uniformly spaced in imagespace, lightspace, noveltyspace, or innovationspace, such as by using the VideoOrbits algorithm of the above mentioned “Intelligent Image Processing” textbook. More generally, the dots represent measurement data captured by a recording device of the invention, as applied to a variety of possible signal recording applications.

Here in FIG. 2, 25 rows of the matrix are shown, each row depicting the situation at a particular point in time, tₘ, for values of m, ranging from 1 to 25, i.e. at points in time, t₁ through t₂₅, where frame f₂₅ is captured. In general the TimeEl Matrix has dimensions M by N, meaning that it has M rows and N columns. Rows of the matrix are indexed by m, which ranges from 1 to M, where M=25, in this specific example shown in the figure, which depicts how the first 25 frames are captured and stored.

Columns of the TimeEl Matrix indicate the relationship between memory element usage and time. Rows and columns both represent the same units of time, i.e. the reciprocal of the frame rate. In this scenario there is sufficient memory to capture 8 frames, so during a first (re)sparsification regime, s₀, each new frame comes in, as frame number fₙ, where 0<n≤8, i.e. frames f₁ through f₈ and each frame is recorded into memory elements eₙ for 0<n≤8. During the first 8 frame captures, the matrix is lower-triangular. This situation is denoted as (re)sparsification regime S₀. (Re)sparsification regimes 210 comprise four regimes that are shown in this FIG. 2, and these resparsification regimes are denoted as s₀, s₁, s₂, and s₃.

In the field of surveillance video recordings, the concept of a circular buffer is commonly used in which the last L frames are kept, for some value of a memory element array length, L, such as in our case L=8. In this case, each time a new frame comes in we would delete (evict) the oldest frame to make room for the new frame. In this way, we have retroactive recording where we can stop recording and always have the most recent 8 frames. This works well for police encounters where maybe there is a shooting and then we stop the recording and retrieve the pictures of the shooting.

In shootings and mass murders, or jail, prison, riots, etc., we have a world in which there are years of boredom punctuated by seconds of terror.

However, in more general situations, from ordinary life, as well as in artistic applications, there might not be one specific incident of terror that punctuates an otherwise irrelevant and boring timeline. It might be, for example, that the entire timeline and context is of interest, not just a recent event.

In this case, what is shown in FIG. 2 is a resparsifier 211 that matches more closely human visual memory, in which old memories are not deleted entirely, but, rather, fade away slowly and gracefully. In some embodiments of the invention, this graceful fade is done by recompressing old images at a higher compression (e.g. a lower JPEG image compression quality) so that they take up less space. So when the memory is full, rather than delete old images, we recompress old images to make room for new images at full high quality. The resparsifier 211 generates more space by one or more of the following individually or in combination (i.e. a combination of these):
Reduction in spatial resolution of old memories;
Reduction in tonal definition of old memories;
Reduction in numerical fidelity of old memories (e.g. by recompressing at a lower JPEG “Q” or “quality”);
Reduction in temporal resolution of old memories, e.g. deletion of some but not all images in a timeline, so as to maintain a motion picture but at a reduced frame rate.

Let us consider the latter, i.e. resparsifier 211 deletes some of the oldest images, as per rembrance evictor denoted as revictor, 201, to make room for new images. Rather than delete the oldest images only, it reduces the frame rate, so at time t₀, the second oldest memory element is cleared. Then at time t₁₀, the fourth oldest element is cleared. Note that at time t₁₀, the second oldest memory element remains cleared. More generally, once an image is cleared, it is lost, and therefore its absence continues to be manifest itself. Thus at time t₁₀, we see that both the 2nd oldest and the 4th oldest elements are depicted as cleared. We have emphasized this with the hand-drawn “X” in the timeline, but, more generally, this is not necessary as we simply represent this clearing by not showing a black dot in the matrix. Blank space in the matrix indicates emptiness, i.e. a reduction (or complete lack) of image content by way of by resparsifier 211.

Resparsification regimes 210 each have their frame-rates:
Resparsification regime s₀ is none, i.e. elements eᵢ correspond directly to frames fₘ, so i=m;
Resparsification regime s₁ is eviction of even numbered frames, so that ultimately (by time t₁₅) only odd-numbered frames are keptj;
Resparsification regime s₂ is eviction of even numbered of the even numbered frames, so that only odd-odd frames are kept, i.e. untimately (by time t₂₂), only every 4th frame is kept;
Resparsification regime s₃ is eviction of even numbered of the even numbered of the even numbered frames, so that only odd-odd-odd frames are kept, i.e. untimately, only every 8th frame is kept.

Rembrance regimes, 200, each define a specific slope in the matrix:
In rembrance regime r₁ the ratio of the rate of frame capture and growth of the matrix define a slope of 1, meaning that each time a new frame comes in, the matrix grows by one unit in width. In this regime revictor 201 schedules resparsifier 211 to delete even frames and keep odd frames;
In rembrance regime r₂ the slope is 2. In this regime revictor preserves one in four frames;
In regime r₃ the slope is 4, and the revictor preseves one in eight frames.
   Note that in matrix indexing, the first index (the “X-axis”) runs down the page, and the second index, (the “Y-axis”) runs across the page, so slope zero runs down the page and an infinite slope runs across the page.

Thus specifying a TimeEl Matrix specifies an algorithm for operating a timelapse camera system. The TimeEl Matrix is thus isomorphic to a very precisely defined algorithm that can be implemented in hardware or software or firmware.

Thus if we can precisely define a TimeEl Matrix, we have precisely specified an algorithm to allocate incoming frames of video to memory elements, such as to facilitate infinite recording into finite memory.

A TimeEl Matrix “a” is constructed as follows: Consider the example of a memory capacity of 4 frames. Initially these four frames fill up, e.g. into the first four rows of “a”, as follows (this “code” will run in Octave or Matlab, or the like):

a(1, 1)=1;
a(2, 1:2)=1;
a(3, 1:3)=1;
a(4, 1:4)=1;

Now that the memory is full, we drop to half the frame rate, while evicting (deleting to make space) every second image, after the first (oldest) image which we prefer to keep:

a(5, 1:5)=1; a(5,2)=0;
a(6, 1:6)=1; a(6,2:2:4)=0;
a(7, 1:7)=1; a(7,2:2:6)=0;
and the last line of code may be alternatively written as:
a(7, 1:2:4*2)=1;
which, in either case, deletes every second image, while thus recording at a frame rate half what was recorded for the first four images. Thus far we have defined the first seven rows of the TimeEl Matrix. We continue to the next three rows, by capturing at a still lower frame rate of one frame in four (quarter frame rate), and deleting the evens of the evens (i.e. keeping only evens, and deleting even evens, thus deleting every 4th image) as follows:
m a(8, 1:2:5*2)=1; a(8, 3)=0;
a(9, 1:2:6*2)=1; a(9, 3:4:4*2)=0;
a(10,1:2:7*2)=1; a(10, 3:4:6*2)=0;
a(10,1:4:4*4)=1; % same as the line above
and then dropping to quarter frame rate capture and making room by deleting every eight image:
a(11,[1:4:5*4])=1; a(11,5)=0;
a(12,[1:4:6*4])=1; a(12,5:8:4*4)=0;
a(13,[1:4:7*4])=1; a(13,5:8:6*4)=0;
a(13,1:8:4*8)=1; % same as the line above and then dropping to eight frame rate of capture and deleting every sixteenth image:

a(14, 1:8:5*8)=1; a(14, 9)=0;

a(15, 1:8:6*8)=1; a(15, 9:16:4*8)=0;

a(16, 1:8:7*8)=1; a(16, 9:16:6*8)=0;

and then dropping to a reciprocal frame rate, r=16, which corresponds to one sixteenth the original frame rate, and deleting every 2r=32nd image:

m=17;
r=16; % reciprocal frame rate (skip)
a(m,1: r:5*r)=1; a(m, r+1)=0; m=m+1;
a(m,1: r:6*r)=1; a(m, r+1:2*r:4*r)=0; m=m+1;
a(m,1: r:7*r)=1; a(m, r+1:2*r:6*r)=0;
and so on, continuing . . . .

Let b be the base 2 logarithm of the reciprocal frame rate r, so that we can let b go from 0 (i.e. r=1) onwards and upwards as the recording time increases all the way up to B:

m a(1, 1)=1;
a(2, 1:2)=1;
a(3, 1:3)=1;
a(4, 1:4)=1;
m=5;
n for b=0:B % log base 2 of the reciprocal frame rate, r

r=2 . . . ̂b;

a(m, 1:r:5*r)=1; a(m, r+1)=0; m=m+1;

a(m, 1:r:6*r)=1; a(m, r+1:2*r:4*r)=0; m=m+1;

a(m, 1:r:7*r)=1; a(m, r+1:2*r:6*r)=0; m=m+1;

end % for b

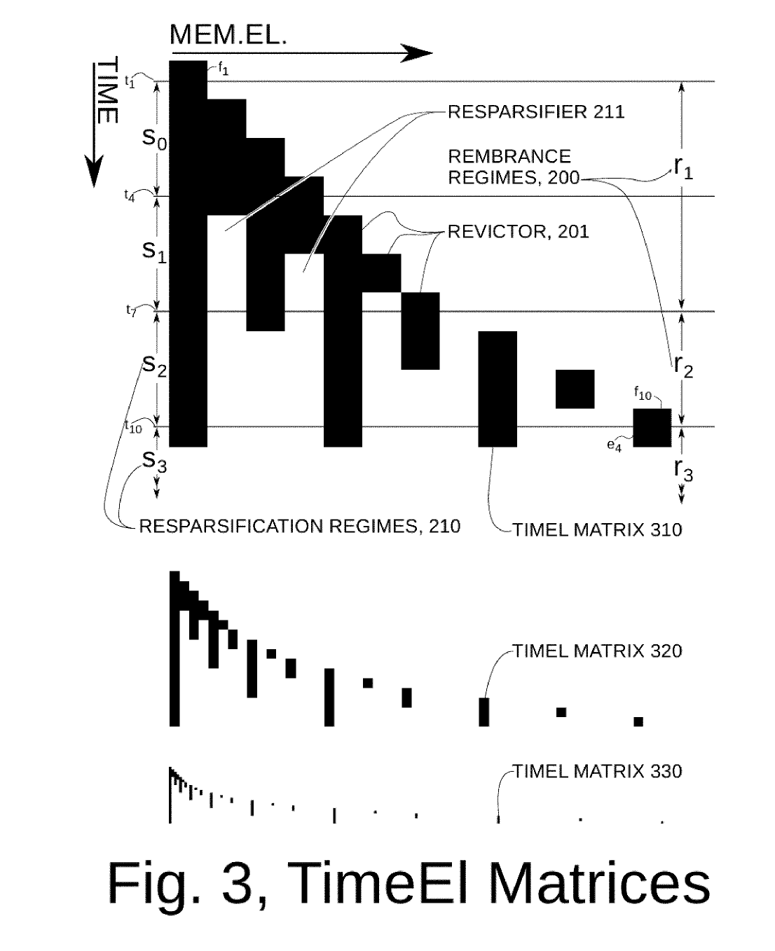

FIG. 3 denotes the TimeEl Matrix 310 for B=1, TimeEl Matrix 320 for B=3, and TimeEl Matrix 330 B=5. The elements of TimeEl Matrix 310 (B=1) are:

$$a = \begin{matrix}1 & 0 & 0 & 0 & 0 & 0 & 0 & 0 & 0 & 0 & 0 & 0 & 0 \\ 1 & 1 & 0 & 0 & 0 & 0 & 0 & 0 & 0 & 0 & 0 & 0 & 0 \\ 1 & 1 & 1 & 0 & 0 & 0 & 0 & 0 & 0 & 0 & 0 & 0 & 0 \\ 1 & 1 & 1 & 1 & 0 & 0 & 0 & 0 & 0 & 0 & 0 & 0 & 0 \\ 1 & 0 & 1 & 1 & 1 & 0 & 0 & 0 & 0 & 0 & 0 & 0 & 0 \\ 1 & 0 & 1 & 0 & 1 & 1 & 0 & 0 & 0 & 0 & 0 & 0 & 0 \\ 1 & 0 & 1 & 0 & 1 & 0 & 1 & 0 & 0 & 0 & 0 & 0 & 0 \\ 1 & 0 & 0 & 0 & 1 & 0 & 1 & 0 & 1 & 0 & 0 & 0 & 0 \\ 1 & 0 & 0 & 0 & 1 & 0 & 0 & 0 & 1 & 0 & 1 & 0 & 0 \\ 1 & 0 & 0 & 0 & 1 & 0 & 0 & 0 & 1 & 0 & 0 & 0 & 1\end{matrix}$$

where the fourth row, seventh row, and tenth row correspond to capture at r=1, r=2, and r=4, respectively.

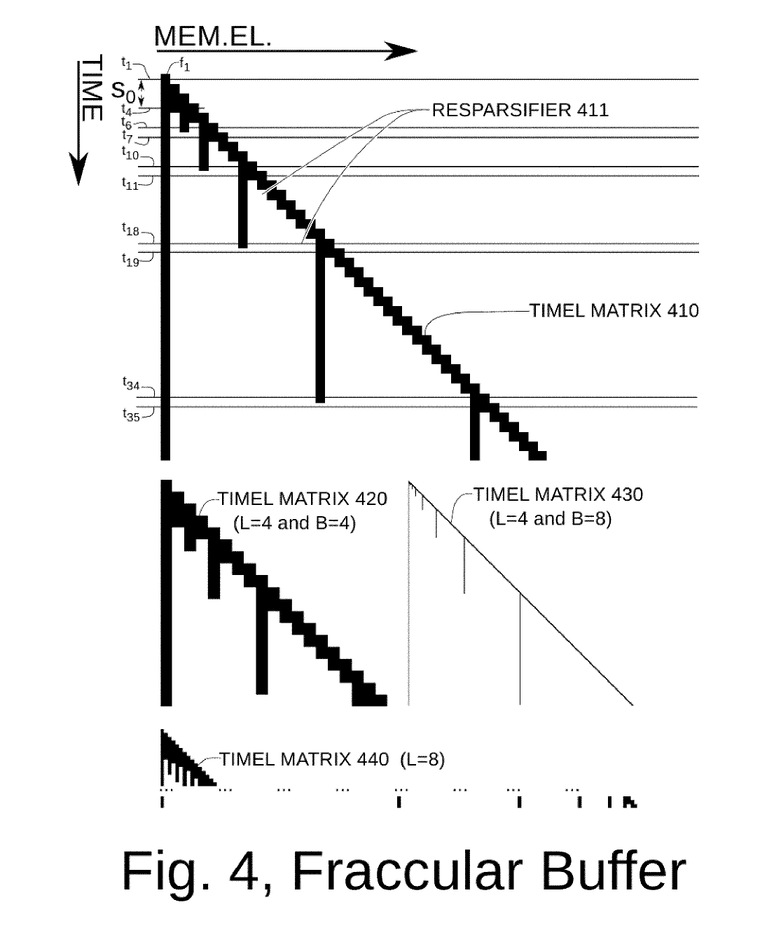

FIG. 4 denotes the TimeEl Matrix 410 for a Fraccular™ Buffer. A Fraccular Buffer is a Fractally Circular Buffer. In this example, the memory element array length, L=4. The algorithm proceeds as follows:
−1. Limited memory: There are never more than 4 frames in each timerow;
2. Recentism: The two most recent frames are always consecutive;
3. Breadth: The oldest frame is always kept;
4. Semimonotonicity: frame-rate must either stay the same or increase with time;
5. Logtime: when two choices both meet all the above, choose logarithmic sampling over keeping (apart from the first frame) only recent frames;
6. Frames don't re-appear once deleted.

Here the frame rate does not decay as it did in the TimeEl Matrices of FIG. 3. Also, some portion of the memory element array a is always kept at full temporal resolution, so there will be a consecutive string of ones of length Lᵣ, the length of “recent memory”. In this example, this length Lᵣ=L/2, i.e. “recent memory” is defined as the most recent two frames, which here comprises one half the total of the memory element array length, L. Here “recent memory” Lᵣ=2, i.e. the “recent memory” comprises the last 2 frames.

Memory fades away logarithmically, rather than linearly, so that there is always a semimonotonically decaying frame-rate as we go backwards in time. In other words, as we go backwards in time, the frame rate either stays the same or decreases. Thus yesterday's memory is about half as good as today's memory, and the memory from the day before is about a quarter as good as today's memory, and so on.

Timel Matrix 410 is shown as a 40 by 40 matrix which thus corresponds to 40 time units and 40 memory element usages. The first four rows of Timel Matrix 410, corresponding to time t₁ trough to time t₄ prescribe perfect memory at full frame rate, after which memory is (re)sparsified by resparsifier 411, according to a logarithmic memory fade, very similar to the way that human memory works, in the sense that as memories get older, they fade more.

M=40; N=40; % size of TIMEL MATRIX 410
a=zeros(M,N); % initialize TIMEL MATRIX 410
for m=1:M; a(m,[1:m])=1; end % initialize lower triangular portion to ones
% the following 36 lines of code are the action of SPARSIFIER 411
a(5 :M, 2)=0; % *** zero out the first even column from 5th row
downwards
a(6 :M, 4)=0; % zero out the next even column from 6th row downwards
a(7 :M, 3)=0; % *** need to keep at least 2 recent frames, so drop back
to 3
a(8 :M, 6)=0;
a(9 :M, 7)=0;
a(10:M, 8)=0;
a(11:M, 5)=0; % *** next would result in non-semimonotonicity, so drop 5
a(12:M,10)=0;
a(13:M,11)=0; % delete newer room when possible, i.e. preserve oldest
a(14:M,12)=0;
a(15:M,13)=0;
a(16:M,14)=0;
a(17:M,15)=0;
a(18:M,16)=0;
a(19:M, 9)=0; % *** next would result in non-semimonotonicity, so
drop 9
a(20:M,18)=0;
a(21:M,19)=0;
a(22:M,20)=0;
a(23:M,21)=0;
a(24:M,22)=0;
a(25:M,23)=0;
a(26:M,24)=0;
a(27:M,25)=0;
a(28:M,26)=0;
a(29:M,27)=0;
a(30:M,28)=0;
a(31:M,29)=0;
a(32:M,30)=0;
a(33:M,31)=0;
a(34:M,32)=0;
a(35:M,17)=0; % *** next would result in non-semimonotonicity, so
drop 17
a(36:M,34)=0;
a(37:M,35)=0;
a(38:M,36)=0;
a(39:M,37)=0;
a(40:M,38)=0;

SPARSIFIER 411 is manifest in the last 36 lines of code above, where we can see that most of this is clearing down column m−2 from m down to M (i.e. down to the bottom of the matrix). Only five of these 36 lines of code prescribe otherwise. These five lines are marked in the comments with “***”. The first of these anomalies is to zero out the first even column from the 5th row downwards. The second one is to keep at least two frames in recent memory, i.e. that Lᵣ=2. Beyond that, the anomalies are to preserve the semi-monotonicity requirement.

After the first four rows of perfect memory, the next two rows after time t₄ prescribe odd memory (forgetting even frames) in non-recent memory. This ends at time t=t₆, with perfect recent memory and half-perfect non-recent memory. Next at time t₇ is where the second anomaly occurs, breaking up the linearity of non-recent memory. This is where we first begin to see the logarithmic temporality break up the twofold downsampling of non-recent memory:

1 0 0 0 1 1 1
is the result at t=t₇.

Continuing until the tenth row of TIMEL MATRIX 411, at t=t₁₀, we have perfect recent memory, and quarterspeed non-recent memory:

1 0 0 0 1 0 0 0 1 1
If we were to continue without the next anomaly, we would get:
1 0 0 0 1 0 0 0 0 1 1
and this would give rise to a non-monotonicity, i.e. a situation in which the midrange memory would actually be worse than the oldest memories. Therefore, we introduce the anomaly at time t=t₁₁, and drop the 5th column. This drops our non-recent memory to eighth speed which we continue to time t=t₁₈.

At time t=t₁₉, we'd have non-monotonicity if we didn't drop to sixteenth speed capture, thus we drop the ninth column at t₁₉. We continue to capture at sixteenth speed to t₃₄ and then drop to 1/32 speed at t₃₅ by dropping the 17th column.

The anomalous rows indices are simplified by stripping off the first L rows (in this case the first 4 rows since here L=4) of perfect memory, so that these row indices occur at m=1, 3, 7,15, 31, 63, and so on, i.e. for at =2^{z}−1 for some natural number (i.e. positive integer), z>0, where these rows are indicated with “***” in the comments below:

B=8; % B=4 for TIMEL MATRIX 420, and B=8 for TIMEL MATRIX
430.
M=2..\hat{ }B-1+4; N=2..\hat{ }B-1+4; % good sizes: M=N=2..\hat{ }B+3=7,11,19,35,67,
131, etc..
a=zeros(M,N);
for m=1:M; a(m,[1:m])=1; end % lower triangular
atop=a(1:4,1:M); % top 4 rows are saved for later
a=a(5:M,1:N); % take off top 4 rows to see pattern the easier
%a( 1:M-4, 2)=0; %*** even col
%a( 2:M-4, 4)=0; % even col
%a( 3:M-4, 3)=0; %*** earliest odd col
%a( 4:M-4, 6)=0;
%a( 5:M-4, 7)=0;
%a( 6:M-4, 8)=0;
%a( 7:M-4, 5)=0; %*** next would result in non-semimonotonicity, so
drop 5
%a( 8:M-4,10)=0;
%a( 9:M-4,11)=0; % delete newer row when possible, i.e. preserve oldest
%a(10:M-4,12)=0;
%a(11:M-4,13)=0;
%a(12:M-4,14)=0;
%a(13:M-4,15)=0;
%a(14:M-4,16)=0;
%a(15:M-4, 9)=0; %*** next would result in non-semimonotonicity, so
drop 9
for b=1:B; % log base 2 bit length
for m=2..\hat{ }(b−1):2..\hat{ }b−2; % e.g. 16 to 30
a(m:M-4,m+2)=0; % non-anomalous row
end%for m
m=2..\hat{ }b−1; % *** e.g. 31
a(m:M-4,2..\hat{ }(b−1)+1)=0; % *** anomalous row
end%for b
A=[atop;a]; % put the top 4 rows back on

TIMEL MATRIX 420 is for B=4 with M=N=19 and TIMEL MATRIX 430 is for B=8 with M=N=259. Once again, these matrices are often conceptual constructs for conveying and specifying the algorithm, rather than for being stored in memory, e.g. more typically for B=16, M=N=65539 and we may not wish to store a matrix having M*N=4295360521 elements in memory, but simply implement the above algorithm without ever storing the TIMEL MATRIX.

TIMEL MATRIX 440, of which only the first 15 and last 3 rows are shown, depicts a situation with a memory element array of length, L=8. The last row depicts the situation where a state of completely logarithmic memory fidelity has been attained.

More generally, embodiments of the invention implement mixtures of memory models like linear and logarithmic, as well as mixtures of memory fade models like downsizing and down-compressing.

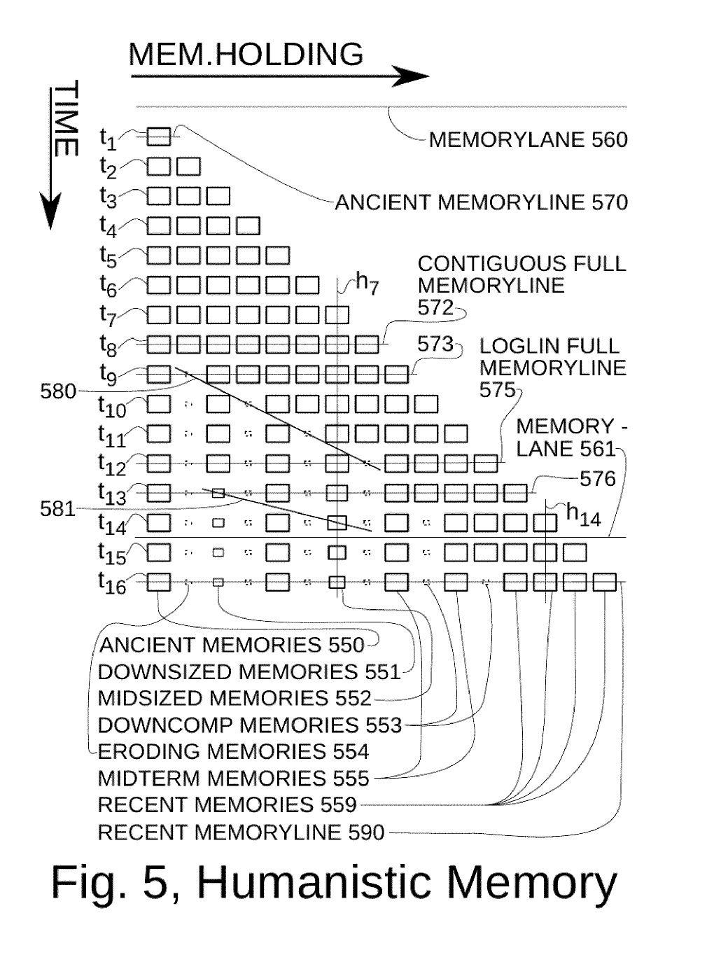

FIG. 5 illustrates a humanistic memory model, humanistic memory buffer, humanistic memory system, or the like. Humanistic Intelligence is well known in the literature:
“Humanistic Intelligence[HI] is intelligence that arises because of a human being in the feedback loop of a computational process . . . ”.
—Ray Kurzweil, Marvin Minsky, and Steve Mann, “The Society of Intelligent Veillance”, IEEE ISTAS 2013.
   Rather than trying to replace humans with computers, HI works to make human superintelligence arise naturally from quickly-responsive feedback loops.

Likewise a camera system can not merely augment human memory but also help improve natural human memory and intellect by creating the right kind of model to help people remember in a more natural way.

The natural way in which human memory works is to remember more recent occurrences with full fidelity, after which memory degrades gracefully.

Electronically captured memory exists on Memorylines™, such as ancient memoryline 572, or more recent memoryline 590. The memoryline is a timeline of images like the timeline in a movie editor program, but with various resolutions, compressions, etc., along the timeline, so as to provide a fading timeline that gracefully fades off into the past. The possibility of electronically captured memory, whether captured or not, exists on Memorylanes™, such as memorylane 560 which existed, for example, before the recording process began, or memorylane 561 which is an interpolated memorylane, which might, for example, be obtained by “reading between the lines” of the memoryline at time t₁₄ and the memoryline at time t₁₅.

The system of FIG. 5 holds memory in a different sort of way, in the sense that there is perfect contiguous full capture up to contiguous full memoryline 572, i.e. there is approximately enough memory to capture eight frames at full resolution and full image quality and full dynamic range. But, unlike the embodiments of FIG. 2 to FIG. 4, here in FIG. 5 we retain more than eight timegrabs, so we no longer think in terms of memory elements, but, rather, in terms of memory holdings. In particular, it is possible with the invention (and perhaps desirable in certain circumstances) to keep at least a little portion of data from each point in time. Thus there can potentially be “holdings” of some sort, at every point in time.

In some embodiments of the invention, we grab small low-resolution test images of a scene at a much higher rate of capture, and then, based on automated image analysis, decide when to capture at full resolution. In some embodiments the low resolution images are simply just a few thousand pixels or a few pixels or even just one pixel, or one average light level, or they derive from another sensor input like a sound sensor (e.g. a microphone is used as a gunshot detector). Thus, more generally, holdings are collections of “gettings”, where a “getting” is the capture of data which can be image data or other data that we use for automation of image data capture. In some embodiments, sensors work in confluence, e.g. the gunshot detector marks images as having higher visual saliency. Other visual saliency indicators include brainwave sensors, heart sensors, and other physiologicals, done by wearable apparatus, or by remote sensing like radar, video (Eulerian Video Magnification or the like), etc. In some embodiments, visual saliency is emotion, along the lines of Rosalind Picard's work on Affective Computing. Generally there is a steady-state memory fade, punctuated by indicators of interest like visual saliency.

A useful embodiment of the invention uses these low-resolution image captures to predict exposure trends to get smoothly varying flicker-free timelapse pictures, with lightspace management. For example, images are captured at a high frame rate and low spatial resolution and analyzed for cloud cover, or the like, to guide the capture of high resolution images to make them more similar to each other thus reducing lightspace flicker. In one embodiment the image capture times are adjusted slightly to bias the capture toward identical lighting, such as lighting where the sun is shining more (or not shining as much), to match previous image captures where the sun was shining more (or less). More generally, exposure and fill flash are adjusted automatically to result in timelapse smoothing, to eliminate timelapse flicker.

Storing these small often very low-resolution test images takes very little memory, and helps to “dot” the memoryline with extra information that is useful in reconstructions and interpolations.

Likewise, frames never need to be totally deleted; they are downsampled, downsized, downgraded, downconverted, downcompressed, or the like. In some embodiments, the downgrading is done by removing random pixels rather than uniform downsizing, so as to facilitate Compressed Sensing reconstruction. In other embodiments, coefficients of transform compression are downscaled according to the less important coefficients of a transform encoding.

At time t₈ the memoryline 572 is full. Capturing a new frame at time t₉ would normally results in eviction of the second holding element of memoryline 573, but instead of deleting the second holding of the memoryline, it is downgraded, to a reduced resolution, reduced dynamic range, and reduced image compression quality, denoted by the smaller rectangle (to denote smaller size) and by a dotted line to denote more pixelation and more harshly quantized Huffman coding tables in transform-based image encoding.

At time t₁₀, the second holding remains downgraded. Once a holding is downgraded the data is permanently lost. Thus if the recording stopped at time t<t₈, we′d recover the second holding at full resolution, but at time t>t₈ we'd only get the second holding at reduced resolution, quality, fidelity, etc. At time t₁₀, the fourth holding is downgraded, in a way similar to the way that the second holding was downgraded at time t=t₉. At time t=t₁₁, the sixth holding is similarly downgraded. At time t=t₁₂, the eighth holding is similarly downgraded. This results in “loglin” (logarithmic/linear) full memoryline 575, with full resolution and full image quality for ever other frame going right back to the beginning, and every frame of recent memories 559.

A downgrader is a device (whether implemented by hard, soft, or firm ware) that accepts a full fidelity image as input, and produces a downgraded image as output. Downgraders for the above second, fourth, sixth, and eighth holdings, form a secondorder resparsifier 580, i.e. one that has a slope of 2 on the Mem.holding versus Time axes. This resparsifier 180 slope defines a (re)sparsifier schedule in resparsifier 580: downgrade every second image until caught up with but not beyond the recent memories 559.

In this embodiment we desire some portion of memory, recently recorded, such as recent memories 599, to be recorded with perfect fidelity. Thus at time t=t₁₃, resparsifier 580 stands down, and does not continue onwards to downgrade the tenth holding. Instead, resparsifier 581 downsizes the third holding, and midsizes the seventh holding, so that every fourth frame is retained at full quality and resolution, and odd frames are retained at full quality but moderate resolution along memoryline 576. The seventh holding, holding h₇, receives its first data at time t=t₇, and begins being resparsified at time t=t₁₃. At time t=t₁₄, the 14th holding h₁₄ receives its first data, such that recent memories 599 comprise frames captured at times t=t₁₁, t₁₂, t₁₃, and t₁₄, and resparsifier 580 comes back to life to resparsify the tenth holding, so that only every fourth frame of non-recent memories is retained at full resolution and quality. There are three such full frames of non-recent memory, so that the memoryline at t₁₄ has only seven frames at full fidelity. For nonrecent memory, the in-between frames comprise downsized memories 551 and midsized memories 552. In this way, there's a reasonable amount of fidelity for every-other-frame (i.e. for all the odd-numbered frames) of non-recent memory. Notice that the memoryline at time t=t₁₄ has some properties of linearity and some properties of logarithmicarity, i.e. the seventh holding is kept at better fidelity than the third holding, thus favouring recent memories over older memories, but still retaining older memories to some degree, as the human mind does.

At time t=t₁₅, a new frame arrives to the fifteenth holding, and to make room for it, the third and seventh holdings are further downgraded. At time t=t₁₆, the twelfth holding is downcompressed to join the ranks of downcomp memories 553, and the third and seventh holdings are further downgraded.

During this process of gracefully forgetting the past, there are certain ancient memories 550 that remain clear. In this embodiment, the first frame is kept at full fidelity, so that we have at least some ancient full fidelity in the oldest memories. But some of the oldest memories that are being downgraded, become further downgraded as eroding memories 554.

In some embodiments, the eroding memories 554 fade out in an approximately logarithmically decaying image resolution, while rolling off also in bitrate (compression versus quality).

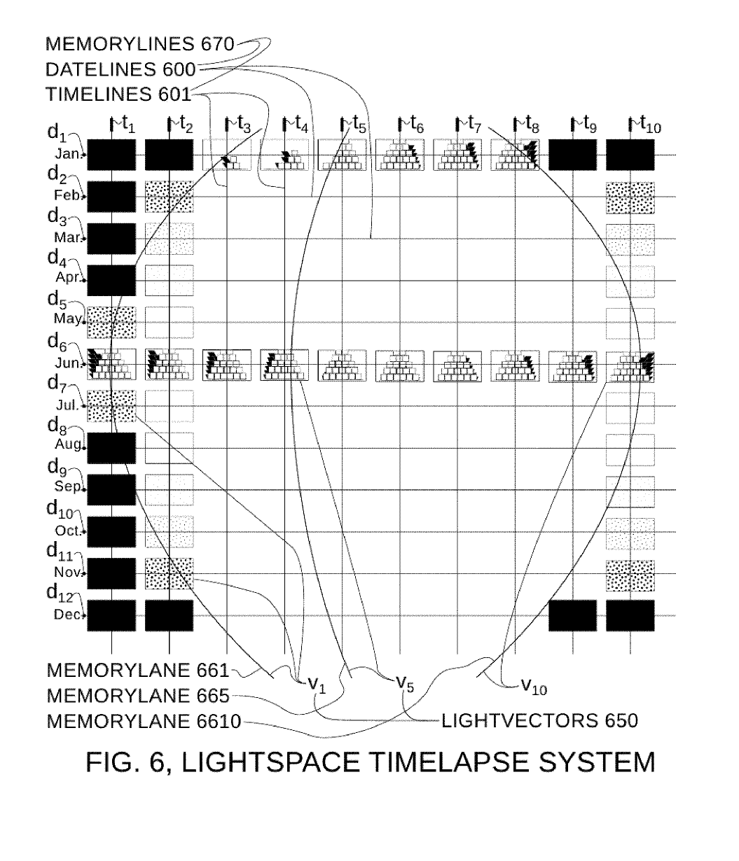

FIG. 6 illustrates a lightspace timelapse embodiment in which a periodic or quasiperiodic occurrence is multidimensionalized. Periodicity or near-periodicity is a feature of many systems, such as, for example, NTSC television signals which may be viewed on an oscilloscope or the like. If a signal generator is connected to an NTSC television, at low frequencies the TV throbs with the screen flickering from black to white back and forth, e.g. at frequencies around a few CPS (Cycle Per Second). In the hundreds of CPS frequency range we see horizontal bars, as we enter the vertical frequency ranges of the TV. In the thousands of CPS range, we see vertical bars, as we enter the horizontal sweep frequency ranges.

Thus we can understand television as a rasterized timescale, where the temporal frames are at low frequencies, the rasters or rows at mid frequencies, and the individual picture elements on the screen at high frequencies.

Like television, there are many other periodic phenomena in life. Another example is the movement of celestial bodies like the sun:

“Tired of lying in the sunshine . . .
So you run and you run to catch up with the sun but it's sinking
Racing around to come up behind you again.
The sun is the same in a relative way but you're older,
Shorter of breath and one day closer to death.
”—Pink Floyd, Time, Mason, Waters, Wright, Gilmour, The Dark Side of The Moon

Each day the sun moves through the sky, creating a sequence of images that each have a particular set of shadows, for each time-of-day. Each morning, the shadows run from east to west. Each afternoon they run from west to east.

Images are therefore grouped by time-of-day, and by date, into a two-dimensional array, as shown in FIG. 6, along datelines 600, one of these datelines defining a row for each day, such as at dates d₁, d₂, d₃, . . . onwards to d₁₂. For simplicity only 12 datelines 600 are shown here, but in practice we might have more datelines like perhaps 365.242 per year, rather than just the 12 shown in this simple illustrative diagram of FIG. 6. Each day the images are organized down a timeline so there are timelines 601 of images all captured at particular times like time t₁, t₂, t₃, . . . t₁₀, . . . .

Thus memorylines 670 comprise both timelines and datelines. In this sense there is a memory array that represents an attempt at organizing the data into a multidimensional array; in FIG. 6, two dimensions, but the number of dimensions is otherwise depending on the phenomenology being studied. For example, looking South from 330 Dundas Street West, we have observed that there was an art gallery (Art Gallery of Ontario) being demolished and rebuilt, over a 5-year period, so it made sense to capture images at each time-of-day, each day, each year, giving rise to a logical 3D array of data, over those 5 years, plus another 5 to 10 years beyond that. As many phenomena may take place over long time periods, we in these embodiments, capture by 3D coordinates: (year, day, time-of-day).

The days in June are longer than the days in January or December, and in fact the longest day is typically June 21, where the sun rises earlier and sets later, whereas on the shortest day typically December 22, the sun rises later and sets earlier.

Accordingly, in some embodiments, we re-sample the data (interpolate) to resynthesize datasets in which each row or column represents shadows from the sun at a particular azimuth. In other embodiments of the invention, capture itself is scheduled to correspond to the sun's azimuth, e.g. one picture for each degree or each five degrees of sun's movement, or the like.

Thus we have lightspaces, giving rise to lightvectors like lightvector v₁ that represents all the pictures taken at sunrise, throughout the year. Not every day is sunny, but some of them are. So a good number of the 365 days of the year, there will be sunny day sunrises that capture the subject matter with good clear long shadows of sunrise. Late morning toward noon, we might have for example, lightvector v₅, say, for example, all the pictures captured at high noon. Lightvector v₁₀ represents all the pictures captured at sunset. These lightvectors define memorylanes like memorylane 661 the defines sunrise pictures, memorylane 665 that defines noon pictures, and memoryline 6610 that defines sunset pictures.

Organizing or capturing the data in this way defines lightvectors 650 that are used to separate azimuth from elevation. In this way such timelapse image capture can be used to generate inverse holograms (e.g. the margoloh, as defined in “Recording ‘Lightspace’ so shadows and highlights vary with varying viewing illumination”, by S. Mann, in Optics Letters, Vol. 20, Iss. 4, 1995).

Specifically, FIG. 6 depicts a construction project, with blocks arranged along the first row, here built in a day (or a month), and then left standing for the remaining days (or months), as the shadows move along. This dataset of lightspaces is then used to synthesize the scene under any desired illumination source lightfield or lightspace, as described in the previously mentioned “Intelligent Image Processing” book.

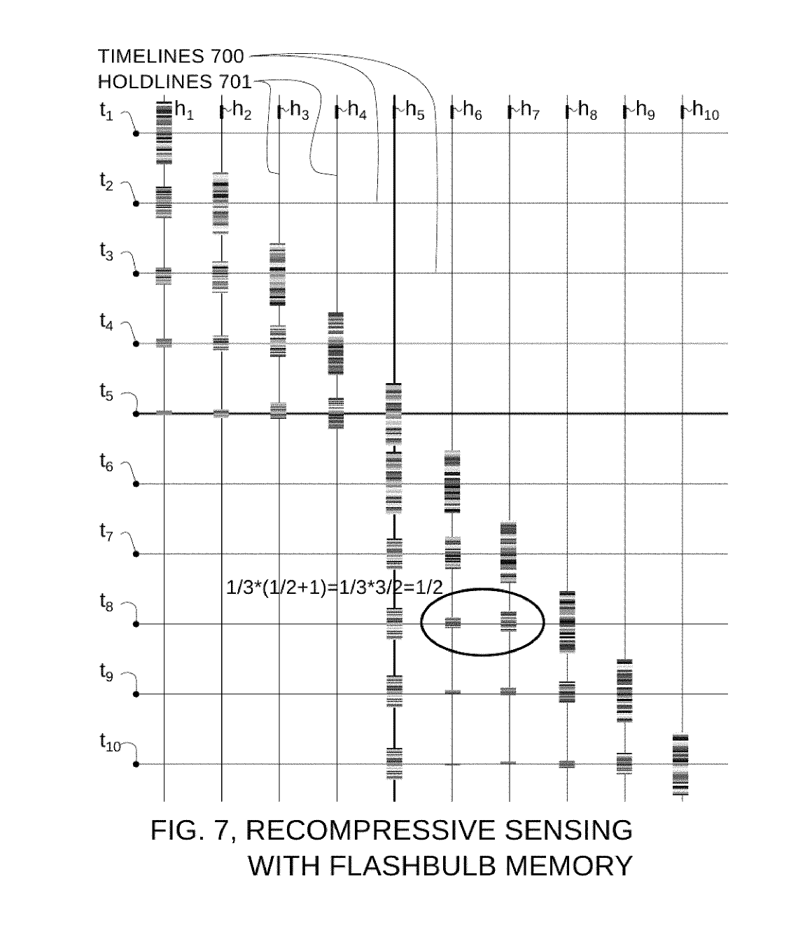

FIG. 7 illustrates a recompressive sensing embodiment of the invention that has “flashbulb memory”. Here the recordings are one-dimensional audio (e.g. sound) recordings. At time t₁ a recording is captured. In FIG. 7 the recordings shown are actual audio files that have been imported, and each has 32 samples in the figure illustration, but in practice, the recordings are longer. Also, we use audio as a mere example of using the invention, whereas these recordings may also be seismic waves, radar, sonar, biosensor signals, or multidimensional audiovisual files including 3D camera images, lidar, or the like.

Let us suppose for our simple example here that we only have enough memory to store two recordings (i.e. two frames of data such as audio records). Thus when a second recording arrives at time t₂, we resparsify the first recording so that it takes up half the space. For example, we throw away every second sample so it only has 16 samples in it instead of 32. Preferably, though, we resparsify its coefficients in a transform space, thus keeping all the samples (to maintain the Nyquist sampling criterion), and only suffering a slight loss in quality.

At time t−3, when a new recording arrives, we resparsify all the old recordings (all two of them) to half their size, to make ample room for the third recording. When a fourth recording comes in at time t₄, we resparsify all three of the older recordings again by half, and so on. Thus holdings h₁, h₂, h₃, and so on, along holdlines 701, decay exponentially, as we progress along timelines 700.

Our plan is simple: each time a new recording arrives, we resparsify everything else we've got, for being down by a factor of two in storage space.

The amount of space that we will need, if we keep doing this for an infinitely long time, is:

C=1+½+¼+⅛+⅙+ 1/32+ 1/64+ . . . =2. (1)

Thus we can record for an infinite duration into a finite amount of memory, i.e. into we can capture an infinite number of audio recordings into a space that only has sufficient memory for two audio recordings.

In some embodiments, we wish to mimic human memory, such as so-called “Flashbulb Memory”, e.g. the way in which people remember all the details of what happens at the time of a significant event. For example, most people old enough to remember the assisination of President Kennedy remember a lot of seemingly minute details of the environment around them when they first heard the news. They often remember—even many years later—the paint colour on the walls in the room they were in when they first heard the news, and the minute details of the designs on the wallpaper, and even which foot was in front of the other foot while they were walking, when the suddenly stopped in shock at the news.

Suppose that at time t₅, some highly significant event occurs, such as a gunshot, as detectable by a gunshot detector in the apparatus of the invention, or by other inputs used with the invention, such as a brainwave sensor or electrocardiographic sensor, shock sensor, vibration sensor, earthquake sensor, seismic sensor, gunfight sensor, or visual saliency sensor (as in the above-mentioned “Intelligent Image Processing” textbook).

The new sample comes in at time t=t₅, and then when the next sample comes in at time t=t₆, in order to make room for it, we simply delete all previous samples, so we now have only the two samples: the current sample at t₆, and the (e.g. gunshot) sample at t₅.

In some embodiments of the invention, it will keep only the gunshot sample and the current sample, and current sample, i.e. remain always thereafter at a simple capacity as:

C=1+1=2. (2)

But more often, we wish to continue to be able to remember things.

So when the next sample arrives at time t=t₇, we instead resparsify the two previous recordings to half their storage capacity, thus using now a total storage capacity at t=t₇ of:

C=1+½+½+ . . . =2. (3)

At time t=t₈ when the next sample comes in, we wish to preserve the t₅ sample at its present value, i.e. prevent it from going down below occupying one half the storage space of one full recording.

To accomplish this, we take the two recordings therebetween, which would normally total 1+½ a recording's worth of data, and drop these to a further ⅓ of their size. This results in:

C=1+⅓(1+½)+½=1+½+½=2. (4)

We apply this rule recursively, resparsifying the recordings between the current recording and the gunshot recording, by ⅓ each time.

In this way we always remember what has happened since the gunshot occurred, but we have a permanent aural memory impairment due to the gunshot effect, as if slightly “deafened” by the gunshot, so that now our sound memories drop off by ⅓ each time rather than only by ½ each time.

So at t=t₉ we have:

C=1+⅓(1+⅓(1+½))+½=1+½+½=2 (5)

Then at t=t₁₀ we have:

C=1+⅓(1+⅓(1+⅓(1+½)))+½=1+½+½=2, (6)

and so on, always being able to record for an infinite duration into a finite memory, while preserving to a very good degree the gunshot recording.

This is a very extreme and simple example, where the permanent impairment is quite profound in its effect on memory, but more typically, we have more memory than used in this example. We might for example have enough memory for a few months worth of recording space, and thus be able to record infinitely and still remember many different important events very well while still not suffering such a strong impairment.

Also, as hard drive costs go down and camera resolutions increase, we have embodiments that allow hot-swappable storage without loss in recordings, and in fact each time the storage is increased, we get a reprieve on resparsifications, for a little while, as we expand into larger space. Likewise as camera resolutions increase, we may upgrade our device while the recording is happening, without interruption thereof. In this way we get infinite recordings in finite memory that stop decaying each time we upgrade.

For example, if the new camera or new audio recorder or device arrives at time t=11 and it has twice or three times the resolution, e.g. in this simple example, maybe 64 samples per recording, and its hard drive is bigger, e.g. twice or three times as big, we don't need to resparsify because the old recordings will look already small in light of the new standards of resolution.

Indeed, old 640×480 recordings don't need to be downgraded when we transition into an HDTV world or 4k video world, because the old recordings already then at that time t=t₁₁ pale in comparison to the whole scale of things at the new time.

So the invention allows for SCALEABLE infinite recording into finite but growing memory.

Michel Foucault, in his seminal book, “Surveiller et Punir”, outlined much of the work on surveillance as of the era of Jeremy Bentham's “Panopticon”, which brought with it the birth of the modern prison, and of the modern “carceral society”, “Carceral archipelago”, and “Prison Planet”.

The English translation of the book was published as “Discipline and Punish”, where the notion of “Surveillance” translates to the notion of “Discipline”, i.e. not merely sensing but also effecting.

To be punished through discipline is to suffer, and the opposite of “to suffer” “to do”. When we think of control theory, we have observability and controllability. Surveillance is often used as a means of control of a society, from top-down.

We live in a world of surveillance, but it doesn't have to be only that way. We aim to create not a surveillance-society, but a veillance society.

“Surveillance” means watching from above (its a French word that translates roughly to “Oversight” in English). Veillance is simple concept==“Sight”==neither from above nor from below. Veillance is a fair and balanced sight, that includes components of surveillance, sousveillance (“undersight”), coveillance, and more importantly, OpenVeillance!

But Veillance is more than just sight. Just as surveillance includes also the hidden microphones and wiretaps of audio conversations, Veillance also includes audio as well as video as well as other sensory dimensions.

And just as Surveillance includes both observability and controllability (i.e. to “Discipline” is not just to sense but also to effect, i.e. both observability and controllability! In this way, Veillance is the more open, fair, and balanced form of control theory through technologically open means.

Just as we have Compressed Sensing, we can also have Compressed Affecting. Compressed Sensing is to observability as Compressed Affecting is to controllability, thus giving rise to the feedback loop of Humanistic Intelligence (See Mann 1998, Proc. IEEE Volume 86, Number 11, entitled “Humanistic Computing”).

As machines are more intricately woven into the fabric of our everyday life, machine intelligence presents existential risks to humankind [Markoff 2015, Bostrom 2014], and we must guard against these risks. But survival of the human race is not enough. We need to ensure we're not living a degraded and debased life under the surveillance of intelligent machines that want to know everything about us and yet reveal nothing about themselves. Take for example television. Early television sets tried to display a picture no matter how bad the signal: It simply did its best to show us a picture at all times, even if that picture was flawed or contained some random noise or optical “snow”. A modern television receiver only allows its owner to see a picture if the television “decides” it is crisp enough to be approved for viewing. Otherwise, the TV set just displays a blue screen with the message “No Signal”. Without continuous feedback, we can't move the antenna a little bit, or wiggle the wires, or quickly try different settings and inputs, to see what improves the picture. Machines have become like great gods, made perfect for worship, and are no longer showing us their flaws that used to allow us to understand them. In a sense the human has been taken out of the feedback loop, and we no longer get to see (and learn from) the relationship between cause (e.g. the position of a TV antenna or wiring) and effect (e.g. the subtle variation in picture quality that used to vary continuously with varying degree of connectivity).

More seriously, as our computers, web browsers, and other “things”, become filled with opaque and mysterious operating systems that claim to be helpful, they actually reveal less about how they work. Like the television with “No Signal”, when our web browser says “Page not found”, in a world of secret technologies, we now know less and less about how our sources of information might be corrupted. Increasingly, the human element in our democracy—public opinion—can be manipulated, without the public knowing why. It all comes back to a simple question: whether we allow technology to be opaque and closed-source, or whether we force it to have the openness of integrity.

In all of these, what we've lost is “observability”, which is a measure of how well the internal states of a machine can be inferred from its external outputs [Kalman 1960].

Machines have inputs and outputs, as do humans. Together that's four in/out paths: Machine in; Machine out; Human in; Human out. But when the human and machine operate together with feedback, there is also Observability and Controllability, which add two more, for a total of six paths, giving rise to a Humanistic Intelligence.

As we build machines that take on human qualities, will they become machines of integrity and loving grace==machines that have the capacity to love and be loved, or will they become machines of hypocrisy==one-sided machines that can't return the love and trust we give to them. If machines are going to be our friends, and if the machines are going to win our trust, then they also have to trust us. Trust is a 2-way street. So if the machines don't trust us and if the machines refuse to show their flaws to us, then we can't trust them. Machines need to show us their imperfections and their raw state, like a good friend or spouse where you trust each other and show yourselves, e.g. naked or unfinished. If machines are afraid to be seen naked or unfinished, then we should not show ourselves in that state to them. Technology that is not transparent cannot be trusted.

Indeed, when machines want to know everything about us, yet reveal nothing about themselves, that's a form of hypocrisy.

The opposite of hypocrisy is integrity. Thus machines observing us, and not themselves observable, are machines that lack integrity.

Observability and integrity require responsiveness (quick immediate feedback) and comprehensibility (making machines that are easy to understand). Systems implementing HI help you understand and act in the world, rather than masking out failure modes as do TV standards like HDMI. Indeed we're seeing a backlash against the “machines as gods” dogma, and a resurgence of the “glitchy” raw aspects of quick responsive comprehensible technologies like vacuum tubes, photographic film, and a return to the “steampunk” aesthetic and incandescent light bulbs (transparent technology).

Machines are driving us insane and making us stupid.

Consuer a “Big Data” and “Little Data” framework as outlined in the following table:

| Big Data | Little Data |
|---|---|
| Artificial Intelligence | Humanistic Intelligence [link] |
| Internet of Things | “Wearables [link]” |
| Smart Things (that sense people) | Smart People (self sensing) |
| Surveillance | Sousveillance [link] |
| (Oversight) | (Undersight) |
| Security | Suicurity [link] |
| Secrecy and Panoptic Privacy | Openness and Genuine Privacy |
| Hypocrisy (Half-Truth) [link] | Integrity (Whole-Truth) [link] |
| Software (typ. closed source) | Computer programs (e.g. GNU) |
| Anti-circumvention laws | Tinkering as a form of inquiry |

Research Priorities for Robust and Beneficial Humanistic Intelligence:

Analogous to the research priorities identified in Max Tegmark's AI Open Letter, a number of important research priorities can be identified for Humanistic Intelligence (HI). This more wholistic framework gives rise to six signal flow paths that more generally define six new human rights for a person using HI. The technologies include:
Videscrow (Escrow of video and other senses);
Priveillance (privacy and veillance);
NotRecord (computionally perfect sensory memory without recording);
Suicurity (counterpoint to security): see Mann, S. (2014). “Personal Safety Devices Enable ‘Suicurity’” IEEE T& S (Technology and Society), 33(2), pp 14-22;
Subjectright (counterpoint to copyright);
Optimum insanity/Lunatic.

Lightspace is a tensor outer product of sensing (lightfields) with affecting (time-reversed lightfields), and more generally, Compressed Control is Compressed Sensing together with Compressed Affecting.

One development from this work is the concept of Optimum Insanity. Insanity is defined as doing the same thing over and over again

There are so many software products that give us a headache and dont really work well. One of the things that weve noticed is that when things dont work, people keep trying the same thing over and over again, expecting a different result. If software doesnt work, the manufacturers or help lines or IT experts tell customers or users or clients to “run it again” or “reboot and try again.” Thats the definition of insanity: doing the same thing over and over again, expecting a different result. So insanity is the new norm. Insanity is in fact a required attribute of the software world.

For a sane person to use the invention, there is a desire to support the four attributes of memory in the Declaration of Veillance, a declaration of the rights and responsibilities of remembering things. See “Declaration of Veillance (Surveillance is Half-Truth)” by Steve Mann, Ryan Janzen, Mir Adnan Ali, and Ken Nickerson, Proc. IEEE GEM 2015, October 2015, Veillance Foundation, 330 Dundas Street West, Toronto, Ontario, Canada M5T 1G5. Therein the four freedoms of veillance memory are being able to See; Understand; Remember; and Share or describe those memories.

One application for recorded memory is Lunatic. Its an insanity embodying application. Its a computer program a user in order to download memories that can run that does the same thing over and over again until it gets a different result. Its like a front end to other software that allows users to click on it once and then itll keep clicking until it gets the result.

The problem is, a lot of existing hardware has software in it and software is often garbage. Thusly, a lot of the hardware has garbage in it, which is not only driving people insane, but is requiring and demanding insanity of us.

Lunatic works as follows: a memoryfile is provided for download. A user running Lunatic can click on a file to download, and Lunatic will determine (by machine learning) the Optimum Insanity™ with which to download the file. The Optimum Insanity is the optimum number of times to spawn the same request multiple times. Typically the Optimum Insanity is 2 or 3 times. Typically, for example, if we're trying to download a video off the Internet, there will come a time now and again when the download takes a really long time. Like a really small file that should download in one minute sits there for an hour doing nothing and if you leave it it will sit for several days doing nothing. In those cases, when you open a new tab and download the same thing again, it often comes in just the one minute.

So instead, every time you click to download a file, Lunatic tries twice in separate threads, to download the same movie or image or timelapse video file.

Then whichever one is successful first, causes the other download to be aborted because it is not needed.

Over time, if this still doesn't work, i.e. if two downloads were issued and both of them happen to get “stuck”, the Optimum Insanity is increased to three. Over time the system learns if this works, and then backs off re-adjusting the Optimum Insanity back down to two, if that works better.

In some embodiments of Lunatic, whenever the Optimum Insanity gets to 8, the 9th thread is run on another remote computer. When it gets to 64, the 65th thread is run on a remote computer in another country. and so on.

One effect of Lunatic is to encourage providers to fix small bugs that are leading to the Insanity inherent in software, especially Closed Source software.

Lunatic is not a Denial of Service (DoS) attack. Infact Lunatic is a Demand for Service (DfS). Lunatic is hopefully something that will only be needed in the short term, until software can be made that no longer requires insanity to use it.

From the foregoing description, it will thus be evident that the present invention provides a design for a LightSpaceTimeLapse camera or processor or service or system, or a similar system, means, apparatus, or the like. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

What is claimed as the invention is:

1. A multimedia recorder, said recorder including a sensor, means for capturing data from said sensor, a processor responsive to an input from said recorder, and memory for storage of said data, said recorder including a resparsifier, said resparsifier pruning older recordings in said data, to higher pruning levels, in response to a fullness of said memory.

2. The recorder of claim 1, where said pruning comprises temporal downsampling of said recordings.

3. The recorder of claim 2, where said temporal downsampling comprises the deletion of the oldest even numbered audiovisual or still image frame or sample.

4. The recorder of claim 2, where said temporal downsampling comprises the deletion of an oldest odd numbered frame or sample.

5. The recorder of claim 1, where said pruning comprises the recompression of the oldest frame or sample, to make room for each arriving new frame or sample.

6. The recorder of claim 1, where said pruning comprises the downsampling of the oldest frame or sample, to make room for each arriving new frame or sample.

7. The recorder of claim 1, where said pruning comprises the downgrading of older frames or samples, to make room for each arriving new frame or sample.

8. The recorder of claim 1, where said pruning comprises the downgrading of every-other frame or sample, to make room for each arriving new frame or sample.

9. The recorder of claim 1, where said pruning comprises a spatiotemporal downsampling of older frames to make room for new arriving frames.

10. The recorder of claim 1, where said pruning comprises a spatiotonal downsampling of older frames or samples to make room for new arriving frames or samples.

11. The recorder of claim 1, where said pruning comprises a tonaltemporal downsampling of older frames to make room for new arriving frames.

12. The recorder of claim 1, where said pruning comprises a spatiotonaltemporal downsampling of older frames to make room for new arriving frames.

13. The recorder of claim 1, where said recorder includes a comparator comparing pairs of incoming images, said processor capturing from said recorder, sparse images, said comparator comparing said sparse images, said processor responsive to an output of said comparator, said processor capturing a full image when said comparator produces a difference beyond a similarity threshold.

14. The recorder of claim 13, where said pruning comprises a novelty downsampling of older frames to make room for new arriving frames.

15. The recorder of claim 13, where said pruning comprises a dissimilarity downsampling of older frames to make room for new arriving frames.

16. A Light Space Time Lapse camera service, said service including an image collector for collecting images from a user or subscriber camera, a processor responsive to an input from said camera, and memory for storage of said data, said service including a resparsifier, said resparsifier pruning older recordings in said data, in response to a fullness of said memory.

17. The service of claim 16, where said memory is not necessarily physically limited memory but rather virtually limited based on financial resources of the user.

18. A Light Space Time Lapse camera system said system including a means for collecting images from a camera, and means for storing the images in a memory, said system including means for resparsification said means for resparsification pruning older images, in response to a fullness of said memory.

19. A multimedia recording device for capturing for a possibly unknown or unbounded duration, into a bounded or finite memory, said device including a sensor, means for capturing data from said sensor, a processor responsive to an input from said sensor, and memory elements for storage of said data, said device including a resparsifier responsive to a fullness of said memory.

20. The recording device of claim 19, said resparsifier downgrading older recordings as new recordings are made from said sensor.

21. The recording device of claim 19, said resparsifier downsampling older recordings as new recordings are made from said sensor.

22. The recording device of claim 19, said resparsifier downcompressing older recordings as new recordings are made from said sensor.
